(19) United States
(12) Patent Application Publication
(10) Pub. No.: US 2009/0125191 A1
(43) Pub. Date: May 14, 2009

(54) Power Steering Apparatus

(75) Inventors: Masakazu KURATA, Yokohama-shi (JP); Toshimitsu Sakaki, Atsugi-shi (JP); Mitsuo Sasaki, Hadano-shi (JP); Tamotsu Yamaura, Atsugi-shi (JP); Mitsuaki Nakada, Atsugi-shi (JP); Kohei Ono, Nagoya-shi (JP); Eiji Kasai, Toyota-shi (JP); Takatoshi Saito, Toyota-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignees: Hitachi, Ltd.; Toyota Jidosha Kabushiki Kaisha

(21) Appl. No.: 12/269,288

(22) Filed: Nov. 12, 2008

(30) Foreign Application Priority Data
Nov. 12, 2007 (JP) 2007-292863

(51) Int. Cl. B62D 5/06; B62D 6/04

(52) U.S. Cl. 701/42; 180/422

(57) ABSTRACT

A power steering apparatus includes a power cylinder; a reversible pump; first and second hydraulic passages; a reservoir tank; a first supply passage arranged to supply the hydraulic fluid through the reversible pump to the second hydraulic passage; a first one-way valve provided in the first supply passage; a second supply passage arranged to supply the hydraulic fluid through the reversible pump to the first hydraulic passage; and a second one-way valve provided in the second supply passage. A Reynolds number of a flow in the first one-way valve is equal to or smaller than 2300 when a flow rate per unit time of the flow in the first one-way valve is maximum. A Reynolds number of a flow in the second one-way valve is equal to or smaller than 2300 when a flow rate per unit time of the flow in the second one-way valve is maximum.

### BACKGROUND OF THE INVENTION

This invention relates to a hydraulic power steering apparatus.

U.S. Pat. No. 7,174,988 (corresponding to Japanese Patent Application Publication No. 2005-47296) shows a power steering apparatus including; an electric motor; a power cylinder having left and right pressure chambers; and a reversible pump driven by the motor, and arranged to supply a fluid pressure selectively to the left and right pressure chambers of the power cylinder to obtain a steering assist force. The power steering apparatus further includes a hydraulic passage and a check valve arranged to supply the hydraulic fluid from a reservoir tank to a hydraulic circuit when the hydraulic fluid is deficient in the hydraulic circuit.

### SUMMARY OF THE INVENTION

However, in this power steering apparatus of the earlier technology, when the piston movement distance per unit time within the power cylinder is large as at the abrupt steering, the hydraulic fluid quantity supplied from the reservoir tank through the hydraulic passage to the hydraulic pressure circuit is temporarily increased. That is, the flow rate per unit time in the check valve is increased. Since the supply of the hydraulic fluid from the pressure chamber on the non-pressurized side is not followed for the pipe resistance with respect to the discharge quantity from the reversible pump, and the deficiency is supplied from the reservoir tank.

It is understood that there are unfocused problems that the hydraulic fluid flow becomes turbulent and the noise is generated when the flow rate per unit time is increased in the check valve by the abrupt steering in the above-described state.

It is an object of the present invention to provide a power steering apparatus devised to solve the above mentioned problem, and to avoid generation of noise at an abrupt steering.

According to one aspect of the present invention, a power steering apparatus comprises: a power cylinder including first and second pressure chambers, the power cylinder being arranged to assist a steering force of a steering mechanism connected with steered wheels; a reversible pump including a first outlet port and a second outlet port, the reversible pump being arranged to supply a hydraulic pressure selectively to the first pressure chamber and the second pressure chamber; a first hydraulic passage connecting the first pressure chamber of the power cylinder and the first outlet port of the reversible pump; a second hydraulic passage connecting the second pressure chamber of the power cylinder and the second outlet port of the reversible pump; a motor arranged to drive the reversible pump; a motor control section configured to output a drive signal to the motor in accordance with a steering assist force applied to the steered wheels; a reservoir tank storing a hydraulic fluid; a first supply passage connected with the reservoir tank, and arranged to supply the hydraulic fluid through the reversible pump to the second hydraulic passage; a first one-way valve provided in the first supply passage, and arranged to allow only a flow from the reservoir tank to the second hydraulic passage; a second supply passage connected with the reservoir tank, and arranged to supply the hydraulic fluid through the reversible pump to the first hydraulic passage; and a second one-way valve provided in the second supply passage, and arranged to allow only a flow from the reservoir tank to the first hydraulic passage, a Reynolds number of a flow of the hydraulic fluid in the first one-way valve being equal to or smaller than 2300 when a flow rate per unit time of the flow in the first one-way valve is maximum, and a Reynolds number of a flow of the hydraulic fluid in the second one-way valve being equal to or smaller than 2300 when a flow rate per unit time of the flow in the second one-way valve is maximum.

According to another aspect of the invention, a power steering apparatus comprises: a power cylinder including first and second pressure chambers, the power cylinder being arranged to assist a steering force of a steering mechanism connected with steered wheels; a reversible pump including a first outlet port and a second outlet port, the reversible pump being arranged to supply a hydraulic pressure selectively to the first pressure chamber and the second pressure chamber; a first hydraulic passage connecting the first pressure chamber of the power cylinder and the first outlet port of the reversible pump; a second hydraulic passage connecting the second pressure chamber of the power cylinder and the second outlet port of the reversible pump; a motor arranged to drive the reversible pump; a motor control section configured to output a drive signal to the motor in accordance with a steering assist force applied to the steered wheels; a reservoir tank storing a hydraulic fluid; a first supply passage connected with the reservoir tank, and arranged to supply the hydraulic fluid through the reversible pump to the second hydraulic passage; a first one-way valve provided in the first supply passage, and arranged to allow only a flow from the reservoir tank to the second hydraulic passage; a second supply passage connected with the reservoir tank, and arranged to supply the hydraulic fluid through the reversible pump to the first hydraulic passage; and a second one-way valve provided in the second supply passage, and arranged to allow only a flow from the reservoir tank to the first hydraulic passage, flows of the hydraulic fluid in the first and second one-way valves being laminar flows when a flow rate per unit time of a flow in the reversible pump is maximum.

According to still another aspect of the invention, a power steering apparatus comprises: a power cylinder including first and second pressure chambers, the power cylinder being arranged to assist a steering force of a steering mechanism connected with steered wheels; a reversible pump including a first outlet port and a second outlet port, the reversible pump being arranged to supply a hydraulic pressure selectively to the first pressure chamber and the second pressure chamber; a first hydraulic passage connecting the first pressure chamber of the power cylinder and the first outlet port of the reversible pump; a second hydraulic passage connecting the second pressure chamber of the power cylinder and the second outlet port of the reversible pump; a motor arranged to drive the reversible pump; a motor control section configured to output a drive signal to the motor in accordance with a steering assist force applied to the steered wheels; a reservoir tank storing a hydraulic fluid; a first supply passage connected with the reservoir tank, and arranged to supply the hydraulic fluid through the reversible pump to the second hydraulic passage; a first one-way valve provided in the first supply passage, and arranged to allow only a flow from the reservoir tank to the second hydraulic passage; a second supply passage connected with the reservoir tank, and arranged to supply the hydraulic fluid through the reversible pump to the first hydraulic passage; and a second one-way valve provided in the second supply passage, and arranged to allow only a flow from the reservoir tank to the first hydraulic passage, the reservoir tank being provided to decrease a temperature of the hydraulic fluid within the reservoir tank.

### BRIEF DESCRIPTION OF THE DRAWINGS

FIG. 1 is a system configuration diagram showing a power steering apparatus according to a first embodiment of the present invention.

FIG. 2 is a top view showing a pump apparatus from which a second housing is removed.

FIG. 3 is a top view showing a first housing of the pump apparatus.

FIG. 4 is an axial sectional view which is taken along a section line A-A of FIG. 5, and which shows the pump apparatus.

FIG. 5 is a front view showing a second housing 12 from which a reservoir tank 9 is removed, as viewed from a positive direction of a z-axis.

FIG. 6 is a sectional view taken along a section line I-I of FIG. 2.

FIG. 7 is an axial sectional view showing a first or second inlet check valve 100 or 200.

FIG. 8 is a view showing a relationship between a flow rate Q and Reynolds number Re of inlet check valve 100.

FIG. 9 is a system configuration diagram showing a power steering apparatus according to a second embodiment of the present invention.

FIG. 10 is a front view showing a second housing 12 of a power steering apparatus according to a third embodiment of the present invention, as viewed from a positive direction of a z-axis.

FIG. 11 is a sectional view in a z-axis direction, showing first and second housings 11 and 12 of a power steering apparatus according to a fourth embodiment of the present invention.

FIG. 12 is a view showing a position relationship between first and second housings 11 and 12 and reservoir tank 9 of a power steering apparatus according to a fifth embodiment of the present invention.

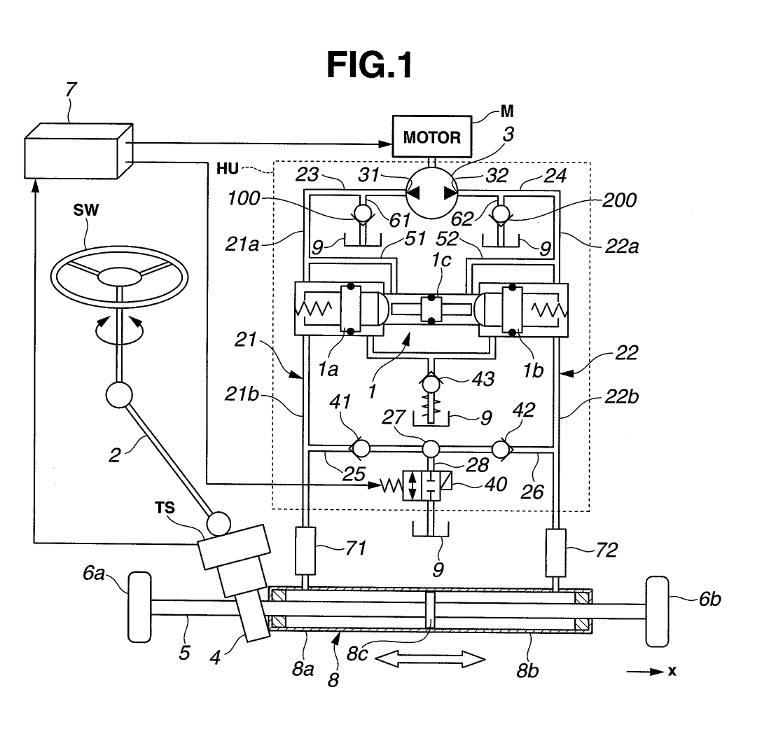

### DETAILED DESCRIPTION OF THE INVENTION

[System Configuration of Power Steering Apparatus] FIG. 1 is a view showing a power steering apparatus according to the present invention. An x-axis is defined by an axial direction of a lack shaft 5. A positive side is defined by a side of a second cylinder 8b of a power cylinder 8.

When a driver steers a steering wheel SW, a pinion 4 is driven through shaft 2. A rack shaft 5 is moved in the axial direction by a rack and pinion mechanism (steering mechanism), and front wheels (steered wheels) 6a and 6b are steered. A torque sensor TS is provided to shaft 2. Torque sensor TS is arranged to sense a steering torque of the driver, and to output a torque signal to a control unit (motor control section) 7.

Rack shaft 5 is provided with a power steering mechanism arranged to assist movement of rack shaft 5 in accordance with the steering torque of the driver. This power steering apparatus includes a reversible pump 3 driven by a motor M; and a power cylinder 8 arranged to move rack shaft 5 in left and right directions. Pump 3, hydraulic passages, and valves of the hydraulic circuit are received within a hydraulic pressure unit HU.

This pump 3 includes a first port 31 and a second port 32 (first and second outlet ports). Power cylinder 8 includes a piston 8c located within power cylinder 8, and arranged to be moved in the axial direction. Piston 8c defines a first cylinder chamber 8a and a second cylinder chamber 8b (first and second pressure chambers).

First cylinder chamber 8a is connected with a first hydraulic passage 21. A third hydraulic passage 23 connects first hydraulic passage 21 and pump 3. Second cylinder chamber 8b is connected with a second hydraulic passage 22. A fourth hydraulic passage 24 connects second hydraulic passage 22 and pump 3. Third and fourth hydraulic passages 23 and 24 are provided, respectively, with first and second supply hydraulic passages 61 and 62 connected, respectively, with a reservoir tank 9.

First and second supply hydraulic passages 61 and 62 are provided, respectively, with first and second inlet check valve (first and second one-way valves) 100 and 200 each arranged to prevent backflow of the hydraulic fluid to reservoir tank 9, and to supply the hydraulic fluid from reservoir tank 9 when the hydraulic fluid is deficient in first and second hydraulic passages 21 and 22.

First and second hydraulic passages 21 and 22 are connected, respectively, with first and second connection passages 25 and 26. First and second connection passages 25 and 26 are connected with each other at a connection portion 27. First and second connection passages 25 and 26 are provided, respectively, with check valves 41 and 42 each arranged to allow only flow to connection portion 27. Moreover, connection portion 27 is connected with reservoir tank 9 through a drain hydraulic passage 28 provided with an electromagnetic switching valve 40. Connection portion 27 is connected or disconnected to reservoir tank 9 by electromagnetic switching valve 40.

In first and second hydraulic passages 21 and 22 between pump 3 and power cylinder 8, there is provided a bypass valve 1. This bypass valve 1 includes a first valve 1a connected with first hydraulic passage 21; a second valve 1b connected with second hydraulic passage 22; and a third valve 1c provided between first and second valves 1a and 1b.

This first valve 1a connects a pump side hydraulic passage 21a and a power cylinder side hydraulic passage 21b of first hydraulic passage 21. First valve 1a is arranged to connect or disconnect between first hydraulic passage 21 and reservoir tank 9. Similarly, second valve 1b connects a pump side hydraulic passage 22a and a power cylinder side hydraulic passage 22b of second hydraulic passage 22. Second valve 1b is arranged to connect or disconnect between second hydraulic passage 22 and reservoir tank 9.

First and second valves 1a and 1b are moved in an x-axis direction, respectively, by the hydraulic pressures within first and second hydraulic passages 21 and 22. First valve 1a is urged by a spring in the positive direction of the x-axis at a normal state in which the assist torque is equal to zero, so as to disconnect (shut off) between first hydraulic passage 21 and reservoir tank 9.

When first valve 1a is moved in the negative direction of the x-axis against the urging force of the spring, first hydraulic passage 21 and reservoir tank 9 are connected. Second valve 1b has a shape symmetrical to first valve 1a. Second valve 1b is urged in the negative direction of the x-axis by a spring. When second valve 1b is moved in the positive direction of the x-axis, second hydraulic passage 22 and reservoir tank 9 are connected.

Third valve 1c is provided between first and second valves 1a and 1b, and arranged to be moved in the x-axis direction. This third valve 1c is moved by a pressure difference between first and second hydraulic passages 21 and 22 to move one of first and second valves 1a and 1b.

When first hydraulic passage 21 is in a high pressure state, first valve 1a is moved in the positive direction of the x-axis. Second valve 1b is pushed and moved in the positive direction of the x-axis, and second hydraulic passage 22 and reservoir tank 9 are connected. Similarly, when second hydraulic passage 22 is in the high pressure state, second valve 1b is moved in the negative direction of the x-axis. First valve 1a is pushed and moved in the negative direction of the x-axis, and first hydraulic passage 21 and reservoir tank 9 are connected.

(First Hydraulic Passage Pressure>Second Hydraulic Passage Pressure) When first hydraulic passage 21 has a pressure higher than a pressure of second hydraulic passage 22, third valve 1c pushes second valve 1b in the positive direction of the x-axis, and second valve 1b is moved in the positive direction of the x-axis. Consequently, second valve 1b is opened, and second hydraulic passage 22 and reservoir tank 9 are connected. First valve 1a is brought to the normal state to disconnect first hydraulic passage 21 and reservoir tank 9.

(First Hydraulic Passage Pressure<Second Hydraulic Passage Pressure) When second hydraulic passage 22 has a pressure higher than a pressure of first hydraulic passage 21, third valve 1c pushes first valve 1a in the negative direction of the x-axis, and first valve 1a is moved in the negative direction of the x-axis. Second valve 1b is brought to the normal state to disconnect (shut off) between second hydraulic passage 22 and reservoir tank 9. First valve 1a is opened to connect first hydraulic passage 21 and reservoir tank 9.

First and second valves 1a and 1b are connected, respectively, through a back pressure valve 43 to reservoir tank 9. Back pressure valve 43 is arranged to allow only flows from first and second valves 1a and 1b to reservoir tank 9, and to prevent the back flow from reservoir tank 9. By this back pressure valve 43, it is possible to adjust the balance of the fluid amount, to prevent the pressure from accumulating (increasing) in bypass valve 1, and to thereby improve the durability.

Control unit 7 receives the torque signal from torque sensor TS, a transmission signal, a switch signal from an ignition switch, an engine speed signal from an engine speed sensor, and a vehicle speed signal from a vehicle speed sensor. Control unit 7 determines a steering assist force based on these signals, and outputs a command signal to motor M and electromagnetic switching valve 40.

Normally open electromagnetic switch valve 40 is shut off in a normal condition, and opened in a fail condition so as to ensure a manual steering in which the steering is performed by the steering force of the driver at the fail condition of the system. The hydraulic fluid is moved through electromagnetic switching valve 40 between first and second cylinder chambers 8a and 8b to attain the manual steering.

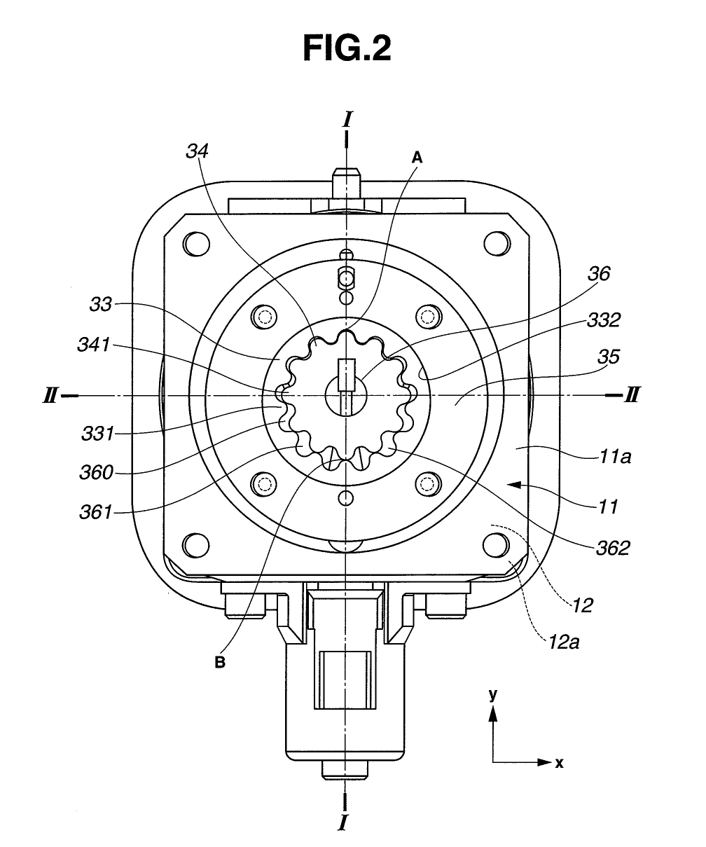

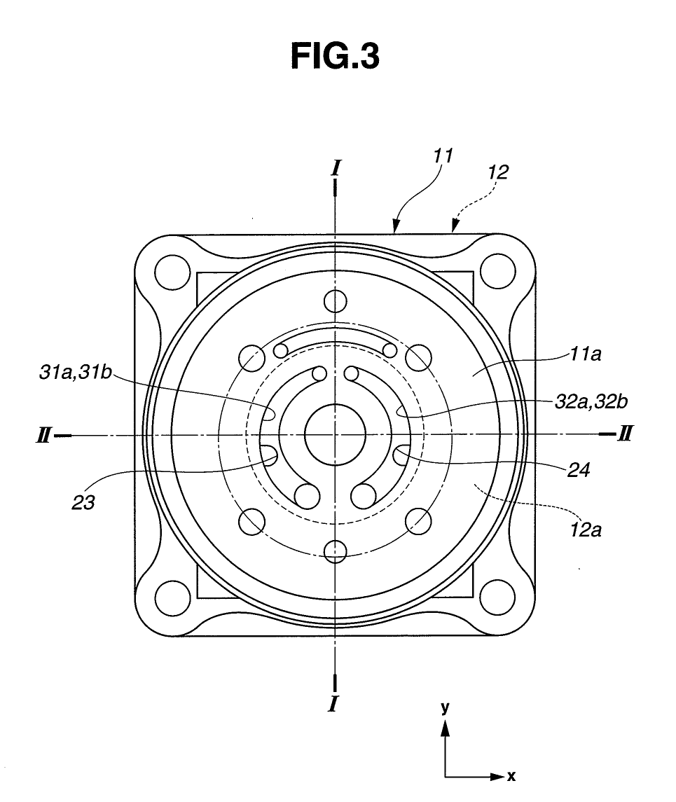

First and second hydraulic passages 21 and 22 includes, respectively, resin pipes or conduits 71 and 72 which are made from synthetic resin, and which are located in power cylinder side hydraulic passages 21b and 22b between power cylinder 8 and connection passages 25 and 26. A part of the hydraulic passage is made from the synthetic resin, and accordingly, it is possible to improve the layout of the pipe, and to stabilize the controllability by reduction of the pulsation of the hydraulic pressure.

[Details of Pump] FIG. 2 is a top view showing pump 3 from which a second housing 12 is removed. FIG. 3 is a top view showing a first housing 11. A z-axis is defined by a normal direction of each of FIGS. 2 and 3. The only first housing 11 is shown in FIGS. 2 and 3. A bottom view of pump 3 from which first housing 11 is removed is identical to FIG. 2. A structure of first housing 11 in which cam ring 35 and so on are received is identical to a structure of second housing 12 in which cam ring 35 and so on are received. Accordingly, explanations of second housing 12 are omitted.

Pump 3 is a reversible pump including first housing 11, second housing 12, an outer rotor 33, an inner rotor 34, a cam ring 35, and a driving shaft 36. Outer rotor 33 is disposed radially between inner rotor 34 and cam ring 35. Outer rotor 33, inner rotor 34, and cam ring 35 are received axially between first and second housings 11 and 12 to be sandwiched by first and second housings 11 and 12.

Outer rotor 33 has an inner circumference provided with an internal gear or internally-toothed gear 331, and an outer circumference 332 on which cam ring 35 is supported rotatably. On the inner circumference of outer rotor 33, there is received inner rotor 34 provided with an external gear or externally-toothed gear 341. Internal gear 331 and external gear 341 have the same pitch. The number of teeth of internal gear 331 is greater than the number of teeth of the external gear 341 by one.

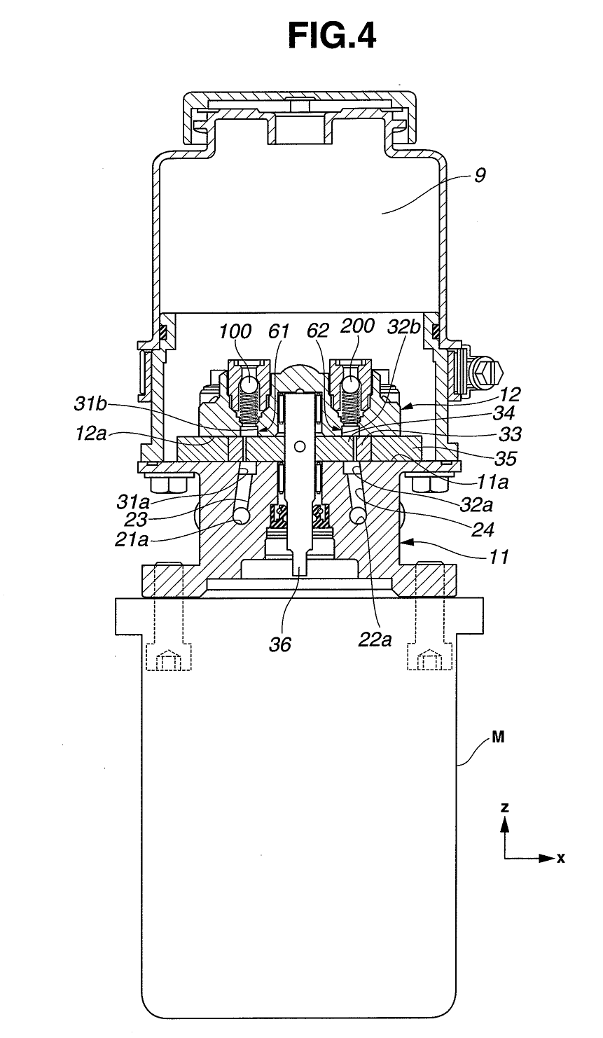

As shown in FIG. 3, a first inlet port or first suction port 31a is provided on a z-axis positive surface 11a of first housing 11 on a left side of line I-I (in a region in a negative direction of the x-axis) of FIG. 3, and a first outlet port or first discharge port 32a is provided on the z-axis positive surface 11a on a right side of line I-I of (in a region of a positive direction of the x-axis) of FIG. 3. First inlet port 31a and first outlet port 32a are located at positions corresponding to internal gear 331 provided in outer rotor 33 and external gear 341 provided in inner rotor 34. Each of first inlet port 31a and first outlet port 32a is opened in the form of the C-shaped form, and closed in the vicinity of line I-I. First inlet port 31a and first outlet port 32a are symmetrical with respect to line I-I, as shown in FIGS. 3 and 4.

Similarly, a second inlet port or second suction port 31b and a second outlet port or second discharge port 32b are provided in second housing 12 at positions corresponding to internal gear 331 and external gear 341. Each of second inlet port 31b and second outlet port 32b is in the form of the C-shaped form, and closed in the vicinity of line I-I.

Outer rotor 33 and inner rotor 34 are received so that internal gear 331 and external gear 341 are engaged with each other. In this case, internal gear 331 is engaged with external gear 341 in an eccentric state that external gear 341 has a center axis which is off a center axis of internal gear 331 because the number of teeth of internal gear 331 is greater than the number of external gear 341 by one. Consequently, there are formed pump chambers 360 separated by internal gear 331 and external gear 341 by the eccentricity.

Because outer rotor 33 has the center axis which is off the center axis of inner rotor 34, internal gear 331 is thickly engaged with external gear 341 toward the positive direction of the y-axis. An engaging portion A of an end portion in the positive direction of the y-axis, internal gear 331 and external gear 341 are completely engaged with each other, so that pump chamber 360 becomes a minimum volume. Internal gear 331 and external gear 341 are disengaged toward the negative direction of the y-axis. At a trapping portion B of an end portion in the negative direction of the y-axis, internal gear 331 and external gear 341 are completely disengaged, so that pump chamber 360 becomes a maximum volume. Besides, at trapping portion B, there is provided a clearance between internal gear 331 and external gear 341 so as to avoid interference of internal gear 331 and external gear 341 so that the clearance becomes substantially zero.

That is, when inner rotor 34 and outer rotor 33 are rotated in a counterclockwise direction, a region (corresponding to first and second inlet ports 31a and 31b) of pump chamber 360 in the negative direction of the x-axis of line I-I (virtual line connecting engaging portion A and trapping portion B) becomes an inlet or suction region 361 whose volume is increased in accordance with the rotation, and a region (corresponding to first and second outlet ports 32a and 32b) of pump chamber 360 in the positive direction of the x-axis of line I-I becomes an outlet or discharge region 362 whose volume is decreased in accordance with the rotation.

Driving shaft 36 provided in parallel to the z-axis is connected to motor M shown in FIG. 1, to drive inner rotor 34. By the engagement of inner rotor 34 and outer rotor 33, inner rotor 34 and outer rotor 33 are rotated with the rotation of driving shaft 36. Driving shaft 36 is arranged to rotate in the forward and reverse directions, so that pump 3 serves as the reversible pump.

The flow rate q of the hydraulic fluid per unit time which flows through pump 3 is a product of an inherent discharge quantity Vth of pump 3 and a rotational speed Nth per unit time of motor M.

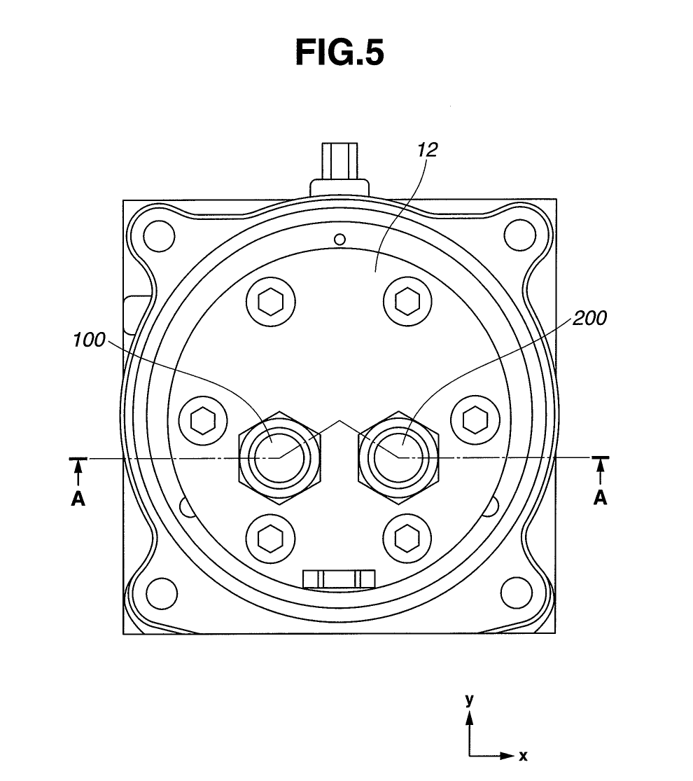

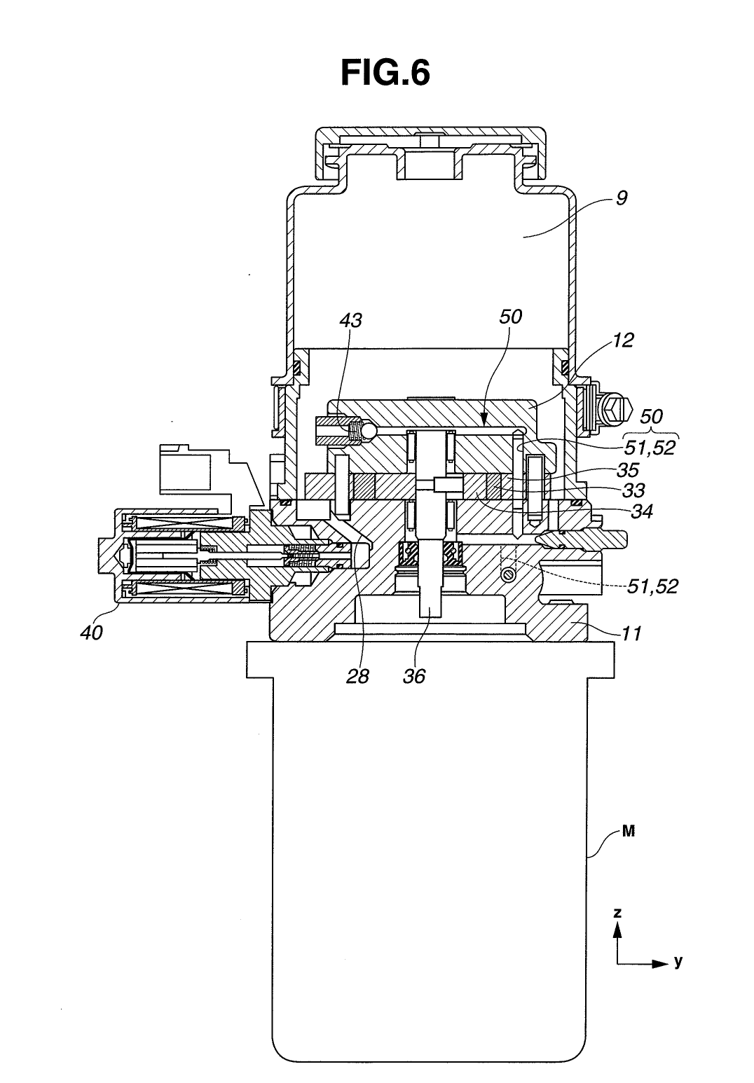

FIG. 4 is an axial sectional view which is taken along a section line IV-IV line of FIG. 5, and which shows the pump apparatus. FIG. 5 is a front view showing second housing 12 from which reservoir tank 9 is removed, as viewed from the positive direction of the z-axis. FIG. 6 is a sectional view taken along a section line I-I of FIG. 2. First housing 11 supports outer rotor 33, inner rotor 34, and cam ring 35 from the negative direction of the z-axis of FIG. 4. Second housing 12 supports outer rotor 33, inner rotor 34, and cam ring 35 from the positive direction of the z-axis of FIG. 4.

As described above, on z-axis positive direction surface 11a of first housing 11, there are provided first inlet port 31a on the negative side of the x-axis of FIG. 3, and first outlet port 31b on the positive side of the x-axis of FIG. 3. On z-axis negative direction surface 12a of second housing 12, there are provided second inlet port 32a on the negative side of the x-axis of FIG. 3, and second outlet port 32b on the positive side of the x-axis of FIG. 3.

Within first housing 11, there are provided hydraulic passages 21a and 22a which connect, respectively, first inlet port 31a and first outlet port 32a to the hydraulic circuit of the power steering apparatus, so as to supply the hydraulic fluid to the hydraulic circuit. Moreover, on the negative side of the z-axis direction of first hosing 11, there is provided motor M connected to driving shaft 36.

On the positive side of the z-axis direction of second housing 12, there is provided reservoir tank 9. Moreover, within the second housing 12, there are provided first and second hydraulic fluid supply passages 61 and 62 which connect, respectively, second inlet and outlet ports 31b and 32b to reservoir tank 9.

First and second inlet check valves 100 and 200 are opened in the z-axis positive direction side surface of second housing 12, and arranged to allow only flows from reservoir tank 9 to pump 3. First and second inlet check valves 100 and 200 are directly connected, respectively, with first and second ports 31 and 32.

In a case in which rack shaft 5 is moved in the positive direction of the x-axis, first cylinder chamber 8a is pressurized and second cylinder chamber 8b is depressurized. In this case, pump 3 sucks from second port 32, and discharges from first port 31.

A length between second port 32 and second cylinder chamber 8b is long, and accordingly a pipe (line) resistance between second port 32 and second cylinder chamber 8b is larger than a pipe resistance from second port 32 through second inlet check valve 200 to reservoir tank 9.

Therefore, pump 3 sucks, immediately after the driving, the hydraulic fluid from reservoir tank 9 through second inlet check valve 200 near second port 32 which is an inlet opening. Pump 3 hardly sucks the hydraulic fluid from second cylinder chamber 8b. In this case, second hydraulic passage 22 and reservoir tank 9 are connected by the bypass valve 1, and accordingly the hydraulic fluid of second cylinder chamber 8b is discharged through second connection passage 26 to reservoir tank 9.

In case of sucking from first port 31 for moving rack shaft 5 in the negative direction of the x-axis, pump 3 similarly sucks through first inlet check valve 100. The hydraulic fluid of first cylinder chamber 8a is discharged through first connection passage 25 to reservoir tank 9.

First and second ports 31 and 32 of pump 3 are connected with first and second inlet check valves 100 and 200, and accordingly it is possible to decrease the suction resistance at the suction, and to suppress the pump load. In this first embodiment, the inlet check valve is composed of two of inlet check valve 100 and inlet check valve 200. However, it is optional to provide three or more check valves if the check valves are provided independently to first and second hydraulic passages 21 and 22.

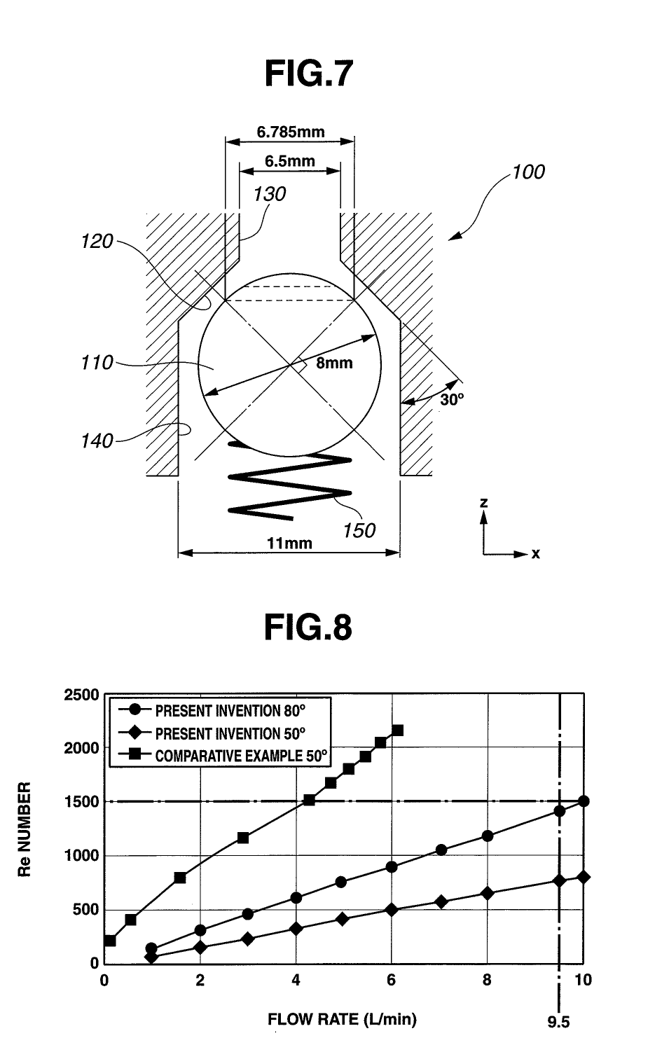

FIG. 6 is a sectional view taken along a section line I-I of FIGS. 2 and 3. Bypass valve 1 is provided in a valve inserting hole of first housing 11. Electromagnetic switching valve 40 is provided in first housing 11 on the negative side of the y-axis. Second housing 12 includes a bypass hydraulic passage 50 having first and second bypass hydraulic passages 51 and 52 connected with each other within second housing 12. This bypass hydraulic passage 50 is opened to reservoir tank 9.

[Details of Inlet Check Valve] FIG. 7 is an axial sectional view showing one of first and second check valves 100 and 200. In this example, at maximum flow rate per unit time, viscosity and flow speed of the hydraulic fluid, and various parameters of inlet check valves 100 and 200 are set to satisfy the following relationship:

Reynolds number Re≦2300 (1)

The Reynolds number is set equal to or lower than 2300, and accordingly it is possible to suppress the generation of turbulence in inlet check valves 100 and 200, and to prevent the noise. The structure of first check valve 100 is identical to the structure of the second check valve 200. Hereinafter, the only check valve 100 will be referred and illustrated.

As shown in FIG. 7, inlet check valve 100 includes a valve element 110; a valve seat 120; an upstream fluid passage 130; a downstream fluid passage 140; and a spring 150. Valve element 110 is urged by spring 150 in the positive direction of the z-axis. Valve element 110 is abutted on taper-shaped valve seat 120, and brought to the closed state. Upstream flow passage 130 and downstream flow passage 140 are shut off from each other. When the pressure on upstream flow passage 130 is greater than the urging force of spring 150, valve element 110 is moved in the negative direction of the z-axis, and brought to the open state. Upstream and downstream fluid passages 130 and 140 are connected with each other.

A minimum fluid passage of inlet check valve 100 is a passage of a clearance L between valve element 110 and valve seat 120 in the open state. The area of the minimum fluid passage is represented by Smin. The fluid area of upstream fluid passage 130 is represented by Sup. In this example, the following relationship is satisfied:

minimum flow passage area Smin≧upstream flow passage area Sup (2)

By this relationship, the pressure decreasing quantity when the hydraulic fluid passes through the minimum fluid passage becomes identical to the pressure decreasing quantity when the hydraulic fluid passes through the upstream fluid passage. The Reynolds number Re at inlet check valve 100 is decreased, and the generation of the turbulence is suppressed.

The maximum flow rate Q at inlet check valve 100 is represented by the following:

Qmax=9.5 L/min

The parameters of inlet check valve 100 are set as shown in FIG. 7 by the following:

A diameter of the valve element=8 mm

A diameter of the upstream fluid passage=6.5 mm

A diameter of the downstream fluid passage=11 mm

A diameter D at an abutment position between valve element 110 and valve seat 120=6.875 mm

A taper angle α of valve seat 120(angle with respect to z-axis)=30°

A spring constant of spring 150=0.05 N/mm However, if the maximum flow rate Qmax=9.5 L/min is satisfied, it is optional to set these parameters to another values.

[Relationship between Flow Rate and Reynolds Number in Inlet Check Valve] FIG. 8 is a view showing relationship between flow rate Q and Reynolds number Re in inlet check valve 100. In a comparative example in which relationships (1) and (2) are not defined like the example of the present invention, at 50° C. of temperature of the hydraulic fluid at which the hydraulic fluid has a high viscosity, the Reynolds number Re is equal to or greater than 1500 (Reynolds number Re≧1500) even when the flow rate is equal to or smaller than 5 L/min. The turbulence is generated in the inlet check valve, and it is not possible to effectively suppress the noise.

In this example according to the present invention, the various parameters of inlet check valve 100 are set to satisfy the relationships of (1) and (2). At the flow rate Q=9.5 L/min (maximum flow rate), the Reynolds number Re is equal to or smaller than 1500 even when the temperature of the hydraulic fluid is 50° C. or 80° C. Accordingly, it is possible to suppress the generation of the turbulence.

The power steering apparatus according to the embodiment of the present invention includes a power cylinder 8 including first and second pressure chambers (8a,8b), the power cylinder 8 being arranged to assist a steering force of a steering mechanism connected with steered wheels (6a,6b); a reversible pump 3 including a first outlet port 31 and a second outlet port 32, the reversible pump 3 being arranged to supply a hydraulic pressure selectively to the first pressure chamber 8a and the second pressure chamber 8b; a first hydraulic passage (21; 21a,21b) connecting the first pressure chamber 8a of the power cylinder 8 and the first outlet port 31 of the reversible pump 3; a second hydraulic passage (22; 22a,22b) connecting the second pressure chamber 8b of the power cylinder 8 and the second outlet port 32 of the reversible pump 3; a motor M arranged to drive the reversible pump 3; a motor control section 7 configured to output a drive signal to the motor M in accordance with a steering assist force applied to the steered wheels (6a,6b); a reservoir tank 9 storing a hydraulic fluid; a first supply passage 61 connected with the reservoir tank 9, and arranged to supply the hydraulic fluid through the reversible pump 3 to the second hydraulic passage 22; a first one-way valve 100 provided in the first supply passage 61, and arranged to allow only a flow from the reservoir tank 9 to the second hydraulic passage 22; a second supply passage 62 connected with the reservoir tank 9, and arranged to supply the hydraulic fluid through the reversible pump 3 to the first hydraulic passage 21; and a second one-way valve 200 provided in the second supply passage 62, and arranged to allow only a flow from the reservoir tank 9 to the first hydraulic passage 21. A Reynolds number of a flow of the hydraulic fluid in the first one-way valve 100 is equal to or smaller than 2300 when a flow rate Q per unit time of the flow in the first one-way valve 100 is maximum (Q=9.5 L/min). A Reynolds number of a flow of the hydraulic fluid in the second one-way valve 200 is equal to or smaller than 2300 when a flow rate Q per unit time of the flow in the second one-way valve 200 is maximum (Q=9.5 L/min).

Accordingly, it is possible to suppress the generation of the turbulence in inlet check valves 100 and 200, and to prevent the noise.

In the power steering apparatus according to the embodiment of the present invention, the first hydraulic passage 21 includes a pipe made from a synthetic resin; and the second hydraulic passage 22 includes a pipe made from a synthetic resin. Accordingly, it is possible to improve the layout of the pipe, and to stabilize the controllability by the reduction of the pulsation of the hydraulic pressure.

In the power steering apparatus according to the embodiment of the present invention, the first one-way valve 100 includes a flow passage having a minimum area which is equal to or greater than a sectional area of a passage on an upstream side of the first one-way valve 100; and the second one-way 200 includes a flow passage having a minimum area which is equal to or greater than a sectional area of a passage on an upstream side of the second one-way valve 200.

Accordingly, it is possible to set the pressure decreasing quantities at passing of the minimum flow passage and at passing of the upstream flow passage to the same value, to decrease the Reynolds number Re in inlet check valve 100, and to suppress the generation of the turbulence.

In the power steering apparatus according to the embodiment of the present invention, the reversible pump 3 includes an inner rotor 34 having external teeth 341, an outer rotor 33 having internal teeth 331, and arranged to be engaged with the inner rotor, a plurality of pump chambers 360 formed between the inner rotor 34 and the outer rotor 33, a first port 31 located on one side of a vertical line connecting an engagement portion A having a minimum volume and a trapping portion B having a maximum volume, and connected with the first hydraulic passage 21, and a second port 32 located on the other side of the vertical line, and connected with the second hydraulic passage 22; the first one-way valve 100 is directly connected with the first port 31; and the second one-way valve 200 is directly connected with the second port 32.

In this example, first and second inlet valves 100 and 200 are directly connected with pump 3, and accordingly it is possible to decrease the suction resistance at the suction, and to suppress the pump load.

In the power steering apparatus according to the embodiment of the present invention, the power steering apparatus further comprises a discharge section arranged to discharge a redundant hydraulic fluid from the first hydraulic passage 21 or the second hydraulic passage 22 to the reservoir tank 9. Accordingly, it is possible to adjust the balance of the fluid amount, to prevent the pressure from accumulating (increasing) in bypass valve 1, and to thereby improve the durability.

In the power steering apparatus according to the embodiment of the present invention, the discharge section is a back pressure valve 43 arranged to discharge the redundant hydraulic fluid to the reservoir tank 9 when the hydraulic pressure within the first hydraulic passage 21 or the hydraulic pressure within the second hydraulic passage 22 is equal to or greater than a predetermined value. Accordingly, it is possible to readily form the discharging section.

In the power steering apparatus according to the embodiment of the present invention, flows of the hydraulic fluid in the first and second one-way valves are laminar flows when a flow rate per unit time of a flow in the reversible pump is maximum (Q=9.5 L/min). Accordingly, it is possible to suppress the generation of the turbulence in inlet check valves 100 and 200, and to prevent the noise.

In the power steering apparatus according to the embodiment of the present invention, the flow rate per unit time of the flow of the hydraulic fluid in the reversible pump is a product of an inherent discharge quantity of the reversible pump and the rotational speed per unit time of the motor.

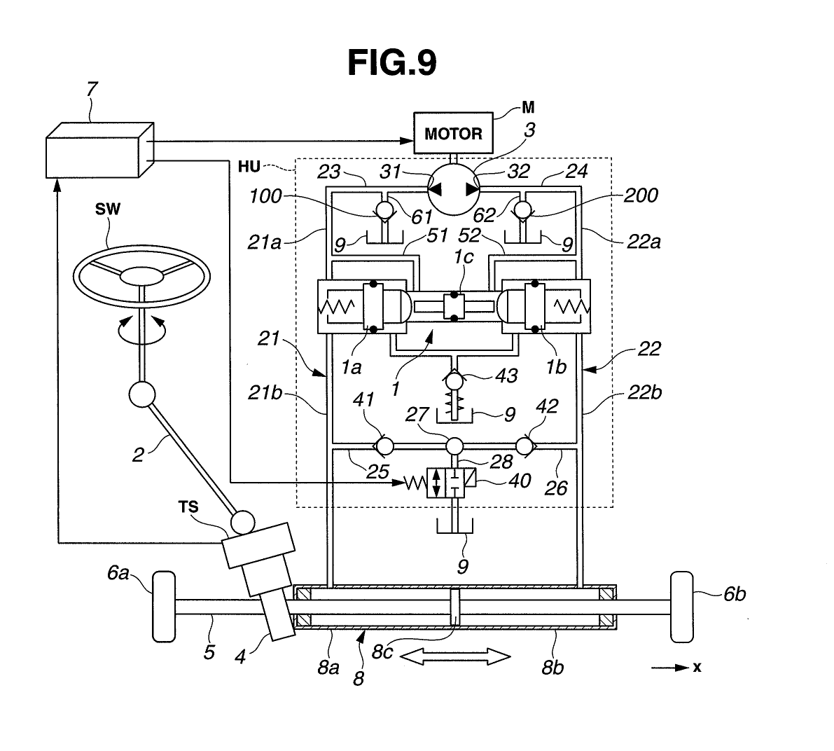

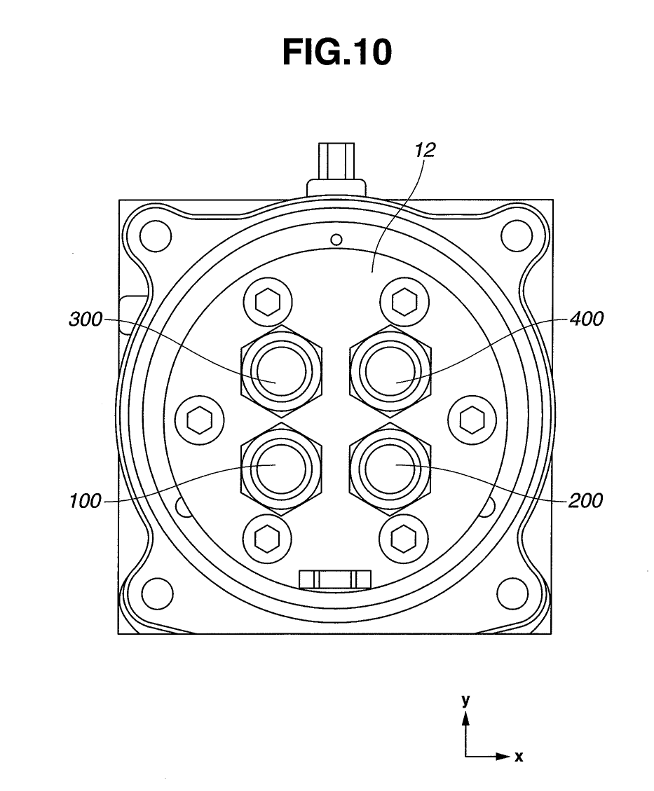

(Second Embodiment) FIG. 9 is a system configuration view showing a power steering apparatus according to a second embodiment of the present invention. The basic structure according to the second embodiment is identical to the structure according the first embodiment. In the first embodiment, the parts of the first and second hydraulic passages 21 and 22 are composed of pipe 71 and 72 made from the synthetic resin. In this second embodiment, the pipe 71 and 72 are not provided, and the entire pipe are made from the steel. Accordingly, it is possible to decrease the expansion of the pipe, and to improve the controllability of the hydraulic pressure.

(Third Embodiment) FIG. 10 is a front view showing a second housing 12 of a power steering apparatus according to a third embodiment of the present invention, as viewed from a positive direction of the z-axis. In the power steering apparatus according to the first embodiment, the inlet check valve is composed of two of first and second inlet check valves 100 and 200. The power steering apparatus according to the third embodiment further includes third and fourth inlet check valves 300 and 400, and the four inlet check valves are provided.

In the power steering apparatus according to the embodiment of the present invention, the power steering apparatus further comprises a third one-way valve 300 arranged to supply the hydraulic fluid from the reservoir tank 9 through the reversible pump 3 to the second hydraulic passage 22, and a fourth one-way valve 400 arranged to supply the hydraulic fluid from the reservoir tank 9 through the reversible pump 3 to the first hydraulic passage 21. Accordingly, the inlet path is increased, and it is possible to improve the inlet efficiency of pump 3.

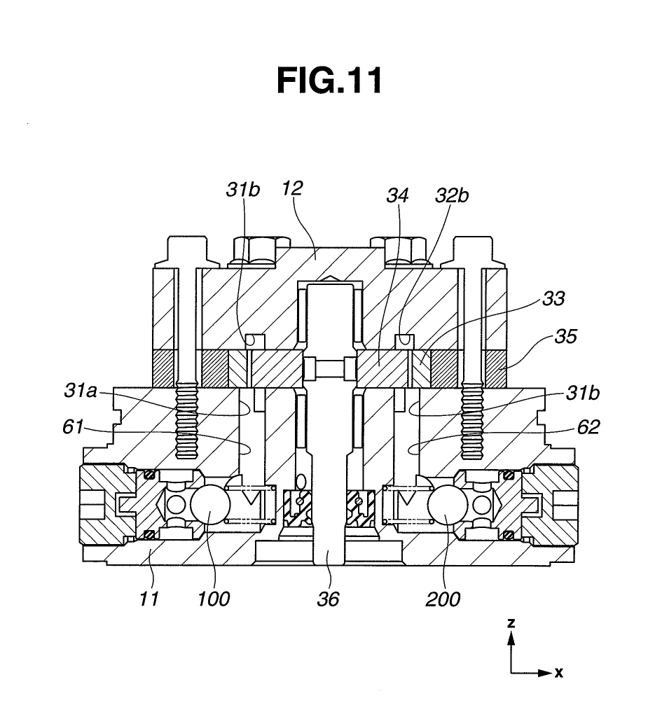

(Fourth Embodiment) FIG. 11 is a sectional view in the z-axis direction, showing first and second housings 11 and 12 of a power steering apparatus according to a fourth embodiment of the present invention. In the power steering apparatus according to the first embodiment of the present invention, first and second inlet check valves 100 and 200 are provided in second housing 12 from the positive direction of the z-axis. In the power steering apparatus according to the fourth embodiment, first and second inlet check valves 100 and 200 are provided in first housing 11 from the positive and negative side of the x-axis. In this power steering apparatus according to the fourth embodiment, it is possible to attain the same effect as the power steering apparatus according to the first embodiment.

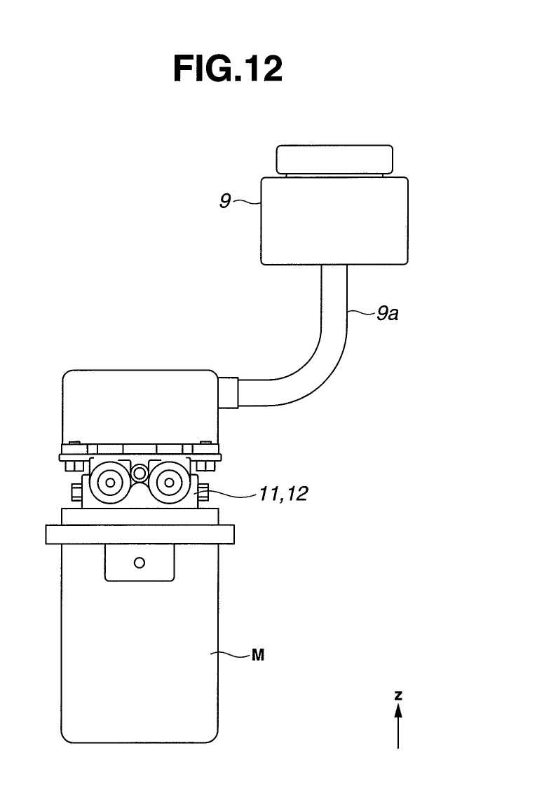

FIG. 12 is a view showing a position relationship between first and second housings 11 and 12, and reservoir tank 9 of the power steering apparatus according to a fifth embodiment of the present invention. The basic structure of the power steering apparatus according to the fifth embodiment is identical to the structure of the power steering apparatus according to the first embodiment. In the power steering apparatus according to the first embodiment, reservoir tank 9 is directly connected with the z-axis positive side of second housing 12. In the power steering apparatus according to the fifth embodiment, reservoir tank 9 is separated from first and second housings 11 and 12. Reservoir tank 9 is connected through a pipe 9a to first and second housing 11 and 12.

In the power steering apparatus according to the embodiment of the present invention, the reservoir tank 9 is provided to decrease a temperature of the hydraulic fluid within the reservoir tank 9. Accordingly, it is possible to prevent the increase of the viscosity, and to decrease the noise in first and second check valves 100 and 200. Moreover, the reservoir tank is disposed at a position different from a position of the motor. Accordingly, it is possible to effectively decrease the temperature of the hydraulic fluid.

This application is based on a prior Japanese Patent Application No. 2007-292863. The entire contents of the Japanese Patent Application No. 2007-292863 with a filing date of Nov. 12, 2007 are hereby incorporated by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A power steering apparatus comprising:
a power cylinder including first and second pressure chambers, the power cylinder being arranged to assist a steering force of a steering mechanism connected with steered wheels;
a reversible pump including a first outlet port and a second outlet port, the reversible pump being arranged to supply a hydraulic pressure selectively to the first pressure chamber and the second pressure chamber;
a first hydraulic passage connecting the first pressure chamber of the power cylinder and the first outlet port of the reversible pump;
a second hydraulic passage connecting the second pressure chamber of the power cylinder and the second outlet port of the reversible pump;
a motor arranged to drive the reversible pump;
a motor control section configured to output a drive signal to the motor in accordance with a steering assist force applied to the steered wheels;
a reservoir tank storing a hydraulic fluid;
a first supply passage connected with the reservoir tank, and arranged to supply the hydraulic fluid through the reversible pump to the second hydraulic passage;
a first one-way valve provided in the first supply passage, and arranged to allow only a flow from the reservoir tank to the second hydraulic passage;
a second supply passage connected with the reservoir tank, and arranged to supply the hydraulic fluid through the reversible pump to the first hydraulic passage; and
a second one-way valve provided in the second supply passage, and arranged to allow only a flow from the reservoir tank to the first hydraulic passage,
a Reynolds number of a flow of the hydraulic fluid in the first one-way valve being equal to or smaller than 2300 when a flow rate per unit time of the flow in the first one-way valve is maximum, and
a Reynolds number of a flow of the hydraulic fluid in the second one-way valve being equal to or smaller than 2300 when a flow rate per unit time of the flow in the second one-way valve is maximum.

2. The power steering apparatus as claimed in claim 1, wherein the first hydraulic passage includes a pipe made from a synthetic resin; and the second hydraulic passage includes a pipe made from a synthetic resin.

3. The power steering apparatus as claimed in claim 1, wherein the first one-way valve includes a flow passage having a minimum area which is equal to or greater than a sectional area of a passage on an upstream side of the first one-way valve; and the second one-way includes a flow passage having a minimum area which is equal to or greater than a sectional area of a passage on an upstream side of the second one-way valve.

4. The power steering apparatus as claimed in claim 1, wherein the reversible pump includes an inner rotor having external teeth, an outer rotor having internal teeth, and arranged to be engaged with the inner rotor, a plurality of pump chambers formed between the inner rotor and the outer rotor, a first port located on one side of a vertical line connecting an engagement portion having a minimum volume and a trapping portion having a maximum volume, and connected with the first hydraulic passage, and a second port located on the other side of the vertical line, and connected with the second hydraulic passage; the first one-way valve is directly connected with the first port; and the second one-way valve is directly connected with the second port.

5. The power steering apparatus as claimed in claim 1, wherein the power steering apparatus further comprises a discharge section arranged to discharge a redundant hydraulic fluid from the first hydraulic passage or the second hydraulic passage to the reservoir tank.

6. The power steering apparatus as claimed in claim 5, wherein the discharge section is a back pressure valve arranged to discharge the redundant hydraulic fluid to the reservoir tank when the hydraulic pressure within the first hydraulic passage or the hydraulic pressure within the second hydraulic passage is equal to or greater than a predetermined value.

7. The power steering apparatus as claimed in claim 1, wherein the power steering apparatus further comprises a third one-way valve arranged to supply the hydraulic fluid from the reservoir tank through the reversible pump to the second hydraulic passage, and a fourth one-way valve arranged to supply the hydraulic fluid from the reservoir tank through the reversible pump to the first hydraulic passage.

8. A power steering apparatus comprising:
a power cylinder including first and second pressure chambers, the power cylinder being arranged to assist a steering force of a steering mechanism connected with steered wheels;
a reversible pump including a first outlet port and a second outlet port, the reversible pump being arranged to supply a hydraulic pressure selectively to the first pressure chamber and the second pressure chamber;
a first hydraulic passage connecting the first pressure chamber of the power cylinder and the first outlet port of the reversible pump;
a second hydraulic passage connecting the second pressure chamber of the power cylinder and the second outlet port of the reversible pump;
a motor arranged to drive the reversible pump;
a motor control section configured to output a drive signal to the motor in accordance with a steering assist force applied to the steered wheels;
a reservoir tank storing a hydraulic fluid;
a first supply passage connected with the reservoir tank, and arranged to supply the hydraulic fluid through the reversible pump to the second hydraulic passage;
a first one-way valve provided in the first supply passage, and arranged to allow only a flow from the reservoir tank to the second hydraulic passage;
a second supply passage connected with the reservoir tank, and arranged to supply the hydraulic fluid through the reversible pump to the first hydraulic passage; and
a second one-way valve provided in the second supply passage, and arranged to allow only a flow from the reservoir tank to the first hydraulic passage,
flows of the hydraulic fluid in the first and second one-way valves being laminar flows when a flow rate per unit time of a flow in the reversible pump is maximum.

9. The power steering apparatus as claimed in claim 8, wherein the flow rate per unit time of the flow of the hydraulic fluid in the reversible pump is a product of an inherent discharge quantity of the reversible pump and a rotational speed per unit time of the motor.

10. The power steering apparatus as claimed in claim 8, wherein the first hydraulic passage includes a pipe made from a synthetic resin; and the second hydraulic passage includes a pipe made from a synthetic resin.

11. The power steering apparatus as claimed in claim 8, wherein the first one-way valve includes a flow passage having a minimum area which is equal to or greater than a sectional area of a passage on an upstream side of the first one-way valve; and the second one-way includes a flow passage having a minimum area which is equal to or greater than a sectional area of a passage on an upstream side of the second one-way valve.

12. The power steering apparatus as claimed in claim 8, wherein the reversible pump includes an inner rotor having external teeth, an outer rotor having internal teeth, and arranged to be engaged with the inner rotor, a plurality of pump chambers formed between the inner rotor and the outer rotor, a first port located on one side of a vertical line connecting an engagement portion having a minimum volume and a trapping portion having a maximum volume, and connected with the first hydraulic passage, and a second port located on the other side of the vertical line, and connected with the second hydraulic passage; the first one-way valve is directly connected with the first port; and the second one-way valve is directly connected with the second port.

13. The power steering apparatus as claimed in claim 8, wherein the power steering apparatus further comprises a discharge section arranged to discharge a redundant hydraulic fluid from the first hydraulic passage or the second hydraulic passage to the reservoir tank.

14. The power steering apparatus as claimed in claim 13, wherein the discharge section is a back pressure valve arranged to discharge the redundant hydraulic fluid to the reservoir tank when the hydraulic pressure within the first hydraulic passage or the hydraulic pressure within the second hydraulic passage is equal to or greater than a predetermined value.

15. The power steering apparatus as claimed in claim 13, wherein the power steering apparatus further comprises a third one-way valve arranged to supply the hydraulic fluid from the reservoir tank through the reversible pump to the second hydraulic passage, and a fourth one-way valve arranged to supply the hydraulic fluid from the reservoir tank through the reversible pump to the first hydraulic passage.

16. A power steering apparatus comprising:
a power cylinder including first and second pressure chambers, the power cylinder being arranged to assist a steering force of a steering mechanism connected with steered wheels;
a reversible pump including a first outlet port and a second outlet port, the reversible pump being arranged to supply a hydraulic pressure selectively to the first pressure chamber and the second pressure chamber;
a first hydraulic passage connecting the first pressure chamber of the power cylinder and the first outlet port of the reversible pump;
a second hydraulic passage connecting the second pressure chamber of the power cylinder and the second outlet port of the reversible pump;
a motor arranged to drive the reversible pump;
a motor control section configured to output a drive signal to the motor in accordance with a steering assist force applied to the steered wheels;
a reservoir tank storing a hydraulic fluid;
a first supply passage connected with the reservoir tank, and arranged to supply the hydraulic fluid through the reversible pump to the second hydraulic passage;
a first one-way valve provided in the first supply passage, and arranged to allow only a flow from the reservoir tank to the second hydraulic passage;
a second supply passage connected with the reservoir tank, and arranged to supply the hydraulic fluid through the reversible pump to the first hydraulic passage; and
a second one-way valve provided in the second supply passage, and arranged to allow only a flow from the reservoir tank to the first hydraulic passage,
the reservoir tank being provided to decrease a temperature of the hydraulic fluid within the reservoir tank.

17. The power steering apparatus as claimed in claim 16, wherein the reservoir tank is disposed at a position different from a position of the motor.

18. The power steering apparatus as claimed in claim 16, wherein the first hydraulic passage includes a pipe made from a synthetic resin; and the second hydraulic passage includes a pipe made from a synthetic resin.

19. The power steering apparatus as claimed in claim 16, wherein the power steering apparatus further comprises a discharge section arranged to discharge a redundant hydraulic fluid from the first hydraulic passage or the second hydraulic passage to the reservoir tank.

20. The power steering apparatus as claimed in claim 16, wherein the power steering apparatus further comprises a third one-way valve arranged to supply the hydraulic fluid from the reservoir tank through the reversible pump to the second hydraulic passage, and a fourth one-way valve arranged to supply the hydraulic fluid from the reservoir tank through the reversible pump to the first hydraulic passage.
